(19) United States
(12) Patent Application Publication
(10) Pub. No.: US 2006/0293767 A1
(43) Pub. Date: Dec. 28, 2006

(54) Policy based automation rule selection control system

(76) Inventors: Todd Michael Eischeid, Cary, NC (US); Mark E. Molander, Cary, NC (US)

Correspondence Address: INTERNATIONAL BUSINESS MACHINES CORPORATION, 650 Harry Road, L2PA/J2C, INTELLECTUAL PROPERTY LAW, SAN JOSE, CA, 95120-6099, US

(21) Appl. No.: 11/170,131

(22) Filed: Jun. 28, 2005

(51) Int. Cl. G05B 11/01; G05B 15/00

(52) U.S. Cl. 700/83; 700/17

(57) ABSTRACT

A method, apparatus and program storage device for managing policy-based automated systems comprising a gravity bar to determine what rule to apply to instances with parameter values between rule spaces. The gravity bar defines a boundary between gap spaces associated with adjoining rule spaces. When a parameter value of an instance being evaluated has a value in a gap space between a rule space and the applicable gravity bar then the instance is handled pursuant to that rule space. A graphical user interface for a policy-based automation system comprises a first rule space, a second rule space and a gravity bar between the two rule spaces. The position of the gravity bar can be adjusted using the graphical user interface. The location of the gravity bar can further be defined to be a function of system operating parameters. A gravity bar can also be defined based on a gravity field of a rule space. Where a gravity bar is defined based on a single rule space, when an instance to be evaluated has a value between two rule spaces the strengths of the gravity fields for the two rule spaces are evaluated. The rule space with the stronger gravity field corresponding to the value of the instance being evaluated determines the handling of the instance.

### BACKGROUND OF THE INVENTION

1. Field of the Invention

The present invention relates to managing computer controlled systems and more particularly, to a method, apparatus and program storage device for managing policy-based automated systems.

2. Description of Related Art

There are a number of significant problems with managing policy-based automated systems, such as enterprise level data storage systems. For example, there are often a large number of complex rules. In the data storage area, a typical enterprise level policy based storage management system may have 10,000 to 100,000 rules. Setting and maintaining such a large number of rules is challenging and resource intensive. Also because managing such a large number of rules often requires multiple system administrators and because there is significant turn over of system administrators, often no one person understands all of the rules.

Gaps between rules and overlaps of rules are another problem with managing policy-based automated systems. An example of a rule gap is if one rule specifies for a certain action to be performed if data has been accessed in the past two weeks and another rule specifies for another action to be performed if data has not been accessed for more than a month and then there is a gap between these two rules for data that has been accessed longer than two weeks ago and less than a month ago. With thousands of rules being maintained by numerous system administrators over long periods of time the rule sets often become disorderly and inefficient. Often, the rules are maintained simply in a textual format, spread across many disparate files. As such, administrators often resort to using single “catch all” type rules for ensuring coverage of rule gaps. Similarly, for rule overlaps, administrators will often apply the first rule identified that matches the criteria. Both of these tactics are inefficient, suboptimal, and set the stage for latent errors and surprises, but they are necessary given current software tools and administrator workload.

A further problem with conventional approaches to managing policy-based automated systems is that there is only a single level of rule control. Thus defining and managing the rules is typically a highly complex process and thereby restricted to highly-trained system administrators instead of end users.

It can be seen that there is a need to provide an improved system of managing policy-based automated systems.

### SUMMARY OF THE INVENTION

To overcome the limitations in the prior art described above, and to overcome other limitations that will become apparent upon reading and understanding the present specification, the present invention discloses a method, apparatus and program storage device for managing policy-based automated systems comprising a gravity bar to determine what rule to apply to instances with parameter values between rule spaces.

A graphical user interface according to the present invention for a policy-based automation system comprises a first rule space, a second rule space and a gravity bar between the two rule spaces. The gravity bar defines a boundary between gap spaces associated with adjoining rule spaces. When a parameter value of an instance being evaluated has a value in a gap space between a rule space and the applicable gravity bar then the instance is handled pursuant to that rule space. The position of a gravity bar can be adjusted using the graphical user interface. The location of the gravity bar can further be defined to be a function of system operating parameters. A gravity bar can also be defined based on a gravity field of a rule space.

In a method of controlling a policy-based automation system according to the present invention first a value of a control parameter is compared to at least a corresponding value of a first rule space; next the value of the control parameter is compared to at least a corresponding value of a second rule space. If the control parameter value is greater than the corresponding value of the first rule space and less than a corresponding value of the second rule space, then the control parameter is compared to a value of a gravity bar function to determine which rule to apply. A further embodiment of the present invention comprises a computer program product comprising a computer usable medium tangibly embodying instructions executable by a processor to perform this method.

In another embodiment of the present invention where a gravity bar is defined based on a single rule space, when an instance to be evaluated has a value between two rule spaces the strengths of the gravity fields for the two rule spaces are evaluated. The instance being evaluated is then handled pursuant to the rule space with the stronger gravity field corresponding to the value of the instance.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a graphical user interface with rule gap and overlap control for a policy-based automation system according to an embodiment of the present invention;

FIG. 2 illustrates a graphical user interface with a rule overlap region according to an embodiment of the present invention;

FIG. 3 illustrates a graphical user interface with two gravity bars in a rule gap space according to an embodiment of the present invention; and

FIG. 4 illustrates a data processing system implementation according to an embodiment of the present invention.

### DETAILED DESCRIPTION OF THE PREFERRED EMBODIMENTS

In the following description of preferred embodiments of the present invention, reference is made to the accompanying drawings, which form a part hereof, and in which is shown by way of illustration specific embodiments in which the invention may be practiced. It is to be understood that other embodiments may be utilized as structural changes may be made without departing from the scope of the present invention.

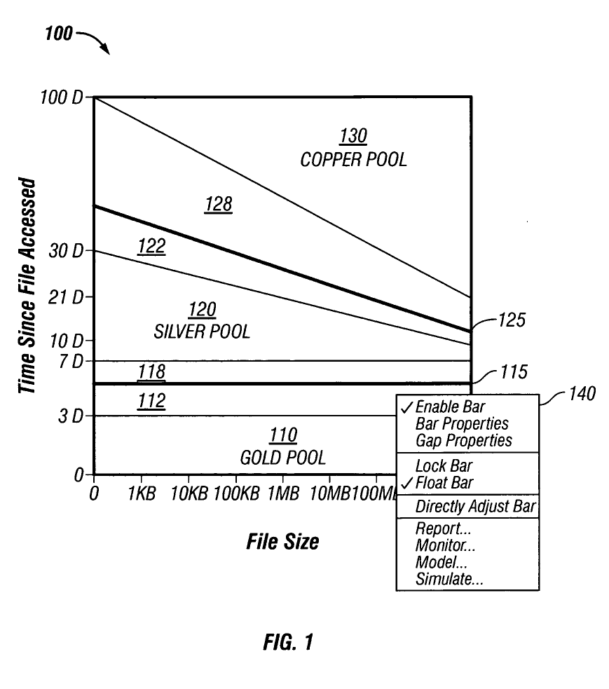

The present invention provides a method, apparatus and program storage device for managing policy-based automated systems. FIG. 1 illustrates a graphical user interface 100 with rule gap and overlap control for a policy-based automation system according to an embodiment of the present invention. In FIG. 1 for illustration purposes a graphical user interface according to the present invention is shown as applied to an automated policy-based storage management system. As will be clear to those of ordinary skill in the art the graphical user interface of the present invention can be used to control a wide range of systems. In FIG. 1 the vertical axis of the graphical user interface represents the time since a file is last accessed. The horizontal axis represents the size of the file. FIG. 1 includes three defined rule spaces Gold Pool 110, Silver Pool 120 and Copper Pool 130. These rule spaces may be defined by a high-level policy author, such as a systems analyst. These rule spaces provide the basic rules that govern how files are to be stored in the storage network. These rules may be defined based on currently available storage capacity and file usage statistics and trends.

The three rule spaces are defined as follows:
Rule 1: Store file in Gold Pool 110 if Time<=3 days
Rule 2: Store file in Silver Pool 120 if (Time is>=7 days) AND ((Size, Time)<=Line (Size=0, Time=30 days) to (Size=10 GB, Time=10 days))
Rule 3: Store file in Copper Pool 130 if (Size, Time)>=Line (Size=0, Time=100 days) to (Size=10 GB, Time=21 days)
   where Time is the amount of time since the file was last accessed; and Size is the size of the file and Size is the file size. Files that were last accessed not more than three days ago are handled pursuant to the definition of the Gold Pool 110 rule space. For example, files in the Gold Pool 110 rule space may be stored in a high-speed, high-reliability Redundant Array of Independent Disks (RAID) storage system. Files that were accessed at least seven days ago and, depending on the file size, not more than 10 to 30 days ago will be handled pursuant to the definition of the Silver Pool 120 rule space. Such Silver Pool 120 files may be stored in lower performance storage systems, such as those with Serial ATA disk drives. Lastly files accessed at least 21 days ago or more, depending on the size, will be handled pursuant to the definition of the Copper Pool 130 rule space. Such Copper Pool 130 files may be stored using tape storage systems, which is typically less expensive than disk storage. Rule space definitions can also include parameters that are a function of at least one operating condition. For example, the definition of the Gold Pool 110 rule space may be defined such when the available Gold Pool storage capacity falls below a threshold level, the maximum number of days since a file has been accessed to qualify for storage in the Gold Pools is reduced.

FIG. 1 includes gap spaces between the three rule spaces. Gap spaces 112 and 118 are between the Gold Pool 110 and Silver Pool 120 rule spaces. Similarly between the Silver Pool 120 rule space and the Copper Pool 130 rule space there are gap spaces 122 and 128. By enabling users to easily control the gap spaces, they can optimize the degree of flexibility for the rules in their policy-based systems. For instance, perhaps the systems analyst wants about 75% of rule evaluations to be more rigidly set, and to allow more potentially variable gap spaces between the rules to account for about 25% of rule evaluations. Defining the size of the gap spaces thus enables the systems analyst to provide a firm foundation of rules (e.g., to apply to 75% of rule evaluations, referred to as a 75% hit rate) as well as to enable the flexibility with the other 25% of evaluations to have them vary based on unforeseen conditions such as spikes in usage patterns, storage availability, etc. More than one person may also be involved in defining the gap spaces, for example, a more technical storage administrator may own and further adjust the harder to optimize rule gap spaces, rather than the general system administrator.

Gravity bars define an equilibrium point, or boundary, between adjacent gravity fields. In FIG. 1, gravity bar 115 is between Gold Pool 110 and Silver Pool 120, and gravity bar 125 is between Silver Pool 120 and Copper Pool 130. Files with attributes between a given rule space and its gravity bar are handled pursuant that rule space. For example, files with attributes in gap space 112 are handled pursuant to Gold Pool 110.

Gravity fields can take a variety of forms. A gravity field can have a uniform strength associated with a rule space. For example:
Rule 1 Gravity strength=60
Rule 2 Gravity strength=40
Rule 3 Gravity strength=70
   For rule spaces that have a uniform gravity strength, the location of a gravity bar is determined by the relationship between the gravity strengths of the adjoining rule spaces. For example the size of gap spaces between two rule spaces may be proportional to the ratio of the associated gravity strengths. In the example shown in FIG. 1 with uniform associated gravity strengths, Gold Pool 110 gap space 112 covers 60% of the area between the Gold Pool 110 rule space and the Silver Pool 120 rule space.

There are a variety of ways a user can set up and control the rule gravities, as well as the relationships between rule gravities. The location of a gravity bar can be adjusted by moving it using a GUI such as shown in FIG. 1, for example by dragging and dropping the gravity bar using an input device such as a computer mouse. Alternatively a gravity bar can be defined by entering an equation defining the location of the gravity bar. A further approach to defining gravity fields is to define a gradient gravity field where the field decreases in strength in relation to the distance from its associated rule space. The strength of the field can be defined by user defined equations.

The location of gravity bars can also float, i.e. their location can be dynamically determined based on one or more time-varying parameters. In float mode, the location of gravity bars can be automatically adjusted to optimize performance based on operating conditions such as for example system resource availability. For example, as more storage capacity becomes available for Gold Pool storage devices, then the gravity strength for the Gold Pool rule space can dynamically increase.

FIG. 1 also illustrates a context menu 140. Context menu 140 can be displayed by for example right clicking a GUI pointing device (such as a mouse) button on a gravity bar. Context menu 140 includes the following menu choices:
Enable Bar—controls whether the gravity bar is displayed in the GUI.
Bar Properties . . . —includes options for users to define an equation that specifies the location of the bar, and to define who can view and who can access these settings, etc.
Gap Properties . . . —includes options for users to define the gravity field associated with a gap space, and to define who can view and who can modify these settings, etc.
Lock Bar—toggles with the Float Bar menu choice. In a locked state a gravity bar will not dynamically move.
Float Bar—toggles with the Lock Bar menu choice. In Float mode the gravity bar position can vary automatically pursuant to a user defined equation specifying dependencies on for example system resources.
Directly Adjust Bar—puts the gravity bar in a mode that allows it to be manually moved with a GUI pointing device.
Report . . . —provides users graphs and charts with status and data collected for the gravity bar and or gap space.
Monitor . . . —provides users an option to set up special monitors to determine when the gravity bar and or gap space meets specified conditions. For instance, a user can set up threshold-triggered alerts (such as if the ratio of adjacent gravity fields becomes larger than 10 to 1 then send the administrator an email alert to check for a potential problem.)
Model . . . —allows a user to simulate system performance based on user defined control settings to see how they might affect system operation before enabling them.
Simulate . . . —similar to Model, but graphically displays the affects of changes to user defined control settings before enabling them.

Dynamic pixel-level fly-over text feedback provides users with information about the current rule space settings, such as when the cursor is pointing to Gold Pool 110 rule space, a pixel-level fly over message may state:
Gold Pool gravity strength=65
Silver Pool gravity strength=30
In 10 days Gold Pool storage expected to reach 85% capacity
In 10 days Silver Pool storage expected to reach 83% of capacity

In a further embodiment, dimensions of the policy space can represent more than one attribute. FIG. 1 illustrates a GUI according to the present invention that uses the last access time of a file as an attribute. Class of Service is an example of a meta-attribute that comprises multiple attributes grouped together. In a storage network where data has associated metadata, the Class of Service meta-attribute can be comprised of the following metadata attributes:
required file access speed;
required storage reliability/availability; and
application priority.
   The storage pool that data is assigned to is then determined based on the Class of Service composite value. The present invention may implemented with any number of rule spaces, including rule spaces with three or more dimensions with multiple GUI screens being used to control rule spaces having more than three dimensions.

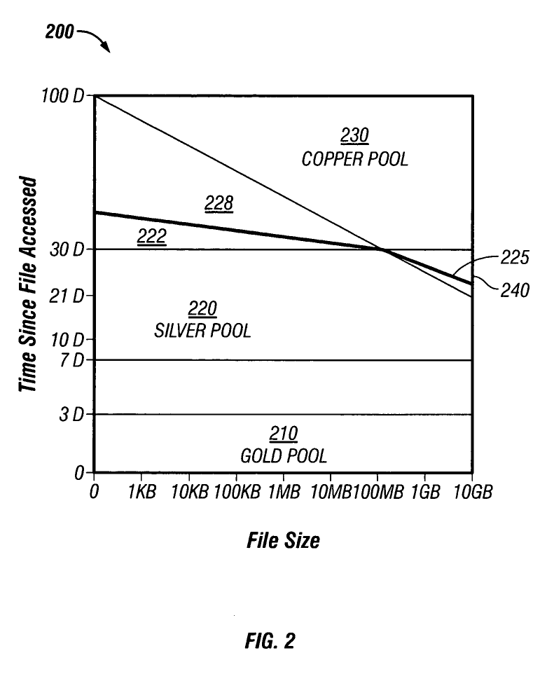

FIG. 2 illustrates a graphical user interface 200 with a rule overlap region according to an embodiment of the present invention. In addition to providing solutions to handling rule space gaps, the present invention also provides solutions for handling rule space overlaps. Graphical user interface 200 includes three rule spaces: Gold Pool 210, Silver Pool 220 and Copper Pool 230. The Silver Pool 220 and Copper Pool 230 rule spaces overlap in region 240. Gravity bar 225 defines the border between gap spaces 222 and 228, as well as the boundary between the Silver Pool 220 and Copper Pool 240 rule spaces in overlap region 240. The gravity bar functionality and options described with respect to gravity bars in rule gap spaces in FIG. 1 also apply to gravity bars in rule overlap regions. Thus gravity fields in overlap regions may be uniform fields or gradient fields. Also, the location of gravity bars in rule overlap regions may be defined by dragging and dropping the bar or by entering an equation for the bar.

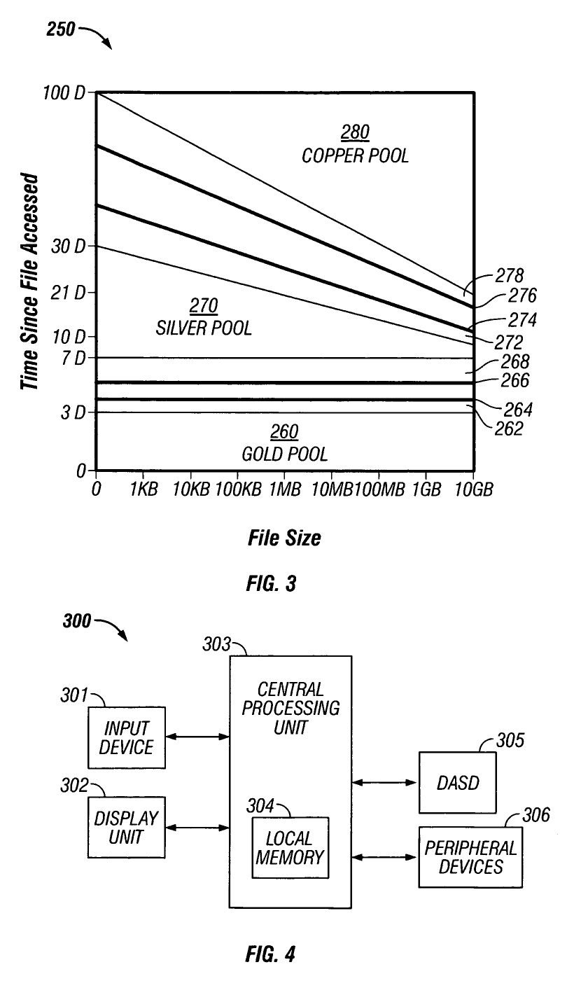

FIG. 3 illustrates a graphical user interface with two gravity bars in a rule gap space according to an embodiment of the present invention. In FIG. 3 a gravity bar is defined with respect to each rule space. Thus the gap spaces between two adjacent rule spaces each have two gravity bars therein, one associated with each of the rule spaces. Gravity bar 264 is defined based on Gold Pool 260; gravity bars 266 and 274 are defined based on Silver Pool 270; and gravity bar 276 is defined based on Copper Pool 280. The controlling rule at a given location between the gravity bars is the rule with the stronger gravity field at that location.

In practice, a systems analyst may define the rule spaces based in part on business considerations. The systems analyst may then leave it to a storage administrator to define the gravity bars between the defined rule spaces based on the storage administrators more detailed knowledge of the storage network and operating parameters. Providing a well-integrated GUI-based policy/rule control system according to the present invention allows higher-level policy definitions to drive and provide a foundation for the automated systems. This simplifies and reduces the number of necessary user-defined rules. In addition the GUI control system of the present invention can be applied to multiple levels of rules. Access and modification rights can be restricted on a per rule and or per rule level basis, for example business analysts may be restricted to access and modify high-level rules/policies, while system administrators may be restricted to access and modify lower-level rule or rule-gap adjustments. Also, the present invention can be used with a wide range of control systems, including for example: storage networks, server networks, manufacturing systems and power systems.

In a preferred implementation, a system according to the present invention is embodied in a data processing system such as system 300 in FIG. 4. System 300 includes components typically associated with conventional data processing systems including without limitation an input device 301 such as a keyboard or other such input apparatus, and a display unit 302, both coupled either locally or via a network connection to a central processing unit (CPU) 303 for exchanging information therewith. The display unit 302 may be used to display a graphical user interface for controlling automated systems pursuant to the present invention, and the input device is utilized to gather from the user responsive information required for implementing the inventive processes presented herein. The CPU 303 includes a local memory element 304 for storing a limited set of commands and data and is further coupled to a storage device 305 such as a direct access storage device (DASD) for storing and retrieving information required for the processing of commands and data at the CPU. An executable program according to the present invention is stored on storage device 305 and may be loaded into local memory element 304. Finally, the CPU may be further coupled either directly or remotely to other peripheral devices 306 which may include additional computer systems via local or wide area networks and the Internet, and which may further include such peripheral devices as printers, facsimile machines, scanners, network connection devices, tape drive units, etc.

While it is understood that the software embodiments of the present invention may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively the process software is sent directly to the client system via e-mail. The process software is then either detached to a directory or loaded into a directory by a button on the e-mail that executes a program that detaches the process software into a directory. Another alternative is to send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

While the present invention has been described in terms of preferred embodiments for achieving this invention's objectives, it will be appreciated by those skilled in the art that variations may be accomplished in view of these teachings without deviating from the spirit or scope of the present invention.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The method form of the invention may be practiced by combining one or more machine readable storage devices containing the code according to the present invention with appropriate standard computer hardware to execute the code contained therein. An apparatus for practicing the invention could be one or more computers and storage systems containing or having network access to computer program(s) coded in accordance with the invention.

What is claimed is:

1. A computer program product comprising a computer usable medium tangibly embodying at least one program of instructions executable by the computer to perform operations to cause a graphical user interface to be displayed, the graphical user interface comprising:
a first rule space;
a second rule space; and
a first gravity bar between the first rule space and the second rule space, wherein a position of the first gravity bar is adjustable using a graphical user interface input device.

2. The computer program product of claim 1 wherein the graphical user interface further comprises:
a first gap space between a boundary of the first rule space and the first gravity bar, the first gap space having an associated first gravity field; and
a second gap space between a boundary of the second rule space and the first gravity bar, the second gap space having an associated second gravity field.

3. The computer program product of claim 2 wherein the graphical user interface is an interface to control a policy based automation system.

4. The computer program product of claim 3 wherein the position of the first gravity bar is automatically adjusted based upon operating parameters of the policy based automation system.

5. The computer program product of claim 4 wherein the first gravity bar further comprises a lock setting wherein the position of the first gravity bar is fixed when the lock setting is enabled.

6. The computer program product of claim 3 wherein a size of the first gap space is proportional to a strength of the first gravity field.

7. The computer program product of claim 3 wherein the first gravity field further comprises a first threshold value wherein if a position of the first gravity bar meets a predetermined condition relative to the first threshold value then the policy based automation system performs a predetermined operation.

8. The computer program product of claim 2 wherein a strength of the first gravity field is a function of a position within the first gravity field.

9. The computer program product of claim 8 wherein a position of the first gravity bar in a view of the graphical user interface is a function of a first variable, and wherein the first variable is a function of a plurality of system operating parameters.

10. The computer program product of claim 1, wherein the graphical user interface further comprises a second gravity bar a second distance from a second rule space boundary and a second gravity field between the second rule space boundary and the first gravity bar, wherein a position of the second gravity bar can be adjusted by moving a visual representation of the second gravity bar.

11. The computer program product of claim 1, wherein a definition of the first rule space further comprises a first parameter which is a function of at least one system operating parameter.

12. A computer system comprising:
a processor;
a memory coupled to the processor, the memory comprising the computer program product of claim 1.

13. A computer program product comprising a computer usable medium tangibly embodying at least one program of instructions executable by the computer to perform operations to control a system, the operations comprising:
receiving a value of a first control parameter;
comparing the value of the first control parameter to at least a corresponding value of a first rule space;
comparing the value of the first control parameter to at least a corresponding value of a second rule space;
if the first control parameter value is greater than the corresponding value of the first rule space and less than a corresponding value of the second rule space, then comparing the first control parameter to a first value of a first gravity bar function to determine which rule to apply.

14. The computer program product of claim 13 wherein the first gravity bar function is a function of a gravity field of the first rule space and of a gravity field of the second rule space.

15. The computer program product of claim 13 the value of the first gravity function is a function of at least one parameter of a policy based automation system.

16. The computer program product of claim 15, wherein a definition of the first rule space further comprises a first parameter which is a function of at least one parameter of the policy based automation system.

17. A method of controlling a system comprising:
receiving a value of a first control parameter;
comparing the value of the first control parameter to at least a corresponding value of a first rule space;
comparing the value of the first control parameter to at least a corresponding value of a second rule space;
if the first control parameter value is greater than the corresponding value of the first rule space and less than a corresponding value of the second rule space, then comparing the first control parameter to a first value of a first gravity bar function to determine which rule to apply.

18. The method of claim 17 wherein the first gravity bar function is a function of a gravity field of the first rule space and of a gravity field of the second rule space.

19. The method of claim 17 wherein a definition of the first rule space further comprises a first parameter which is a function of at least one system operating parameter.

20. A method for deploying computing infrastructure, comprising integrating computer readable code into a computing system, wherein the code in combination with the computing system is capable of performing the method of claim 17.
